(19) United States
(12) Patent Application Publication
(10) Pub. No.: US 2025/0003745 A1
(43) Pub. Date: Jan. 2, 2025

(54) ANGLE DETERMINING METHOD, DEVICE, AND SYSTEM

(71) Applicant: XUZHOU XCMG EXCAVATOR MACHINERY CO., LTD, Xuzhou (CN)

(72) Inventors: Dunkun WANG, Xuzhou (CN); Yuzhong DONG, Xuzhou (CN); Zecheng XING, Xuzhou (CN); Xiangwei LIN, Xuzhou (CN); Hongmin WEI, Xuzhou (CN); Xuefeng YIN, Xuzhou (CN)

(21) Appl. No.: 18/604,781

(22) Filed: Mar. 14, 2024

(30) Foreign Application Priority Data
Jun. 30, 2023 (CN) 202310793075.9

(51) Int. Cl. G01C 1/00; G01B 7/30

(52) U.S. Cl. CPC G01C 1/00; G01B 7/30

(57) ABSTRACT

The present disclosure provides an angle determining method, device, and system. The angle determining method includes: obtaining angle data when an upper mechanism of a split machine rotates to a preset position, the angle data including a first heading angle of the upper mechanism and a second heading angle of a lower mechanism; determining a first absolute value of a difference between the first heading angle and the second heading angle; and determining an actual heading angle of the lower mechanism according to the second heading angle and determining an actual heading angle of the upper mechanism according to the second heading angle and an actual rotation angle between the upper mechanism being at the preset position and the lower mechanism, in a case where a second absolute value of a difference between the first absolute value and the actual rotation angle is greater than a first preset threshold.

### CROSS-REFERENCE TO RELATED APPLICATIONS

The present disclosure is based on and claims priority to China Patent Application No. 202310793075.9 filed on Jun. 30, 2023, the disclosure of which is incorporated by reference herein in its entirety.

### TECHNICAL FIELD

The present disclosure relates to an angle determining method, device, and system.

### BACKGROUND

At present, there are increasing demands for high safety and high operation accuracy in construction. By obtaining an upper mechanism of a split machine and a lower mechanism of the split machine during the operation process, the safety and the operation accuracy of the split machine can be improved.

### SUMMARY

According to one aspect of the present disclosure, an angle determining method is provided. The angle determining method comprises: obtaining angle data when an upper mechanism of a split machine rotates to a preset position, wherein the angle data comprise a first heading angle of the upper mechanism collected by a first sensor and a second heading angle of a lower mechanism of the split machine collected by a second sensor; determining a first absolute value of a difference between the first heading angle and the second heading angle; and determining an actual heading angle of the lower mechanism according to the second heading angle and determining an actual heading angle of the upper mechanism according to the second heading angle and an actual rotation angle between the upper mechanism being at the preset position and the lower mechanism, in a case where a second absolute value of a difference between the first absolute value and the actual rotation angle is greater than a first preset threshold.

In some embodiments, the determining an actual heading angle of the upper mechanism according to the second heading angle and the actual rotation angle comprises: determining the actual heading angle of the upper mechanism according to a sum of the second heading angle and the actual rotation angle.

In some embodiments, the angle determining method further comprises: obtaining a third heading angle of the upper mechanism, the third heading angle being collected by the first sensor when the split machine is started; determining a third absolute value of a difference between a first stored heading angle of the upper mechanism when the upper mechanism is powered off for previous time and the third heading angle; and taking the first stored heading angle as the actual heading angle of the upper mechanism in a case where the third absolute value is greater than a second preset threshold.

In some embodiments, the angle determining method further comprises: obtaining a fourth heading angle of the lower mechanism, the fourth heading angle being collected by the second sensor when the split machine is started; determining a fourth absolute value of a difference between a second stored heading angle of the lower mechanism when the lower mechanism is powered off for previous time and the fourth heading angle; and taking the second stored heading angle as the actual heading angle of the lower mechanism in a case where the fourth absolute value is greater than a third preset threshold.

In some embodiments, the angle determining method further comprises: obtaining a fifth heading angle of the lower mechanism, the fifth heading angle being collected by the second sensor in a case where the split machine enters a first travel state from a non-travel state and a duration of the first travel state is less than a first preset time; determining a fifth absolute value of a difference between the fifth heading angle and a sixth heading angle, wherein the sixth heading angle is a third stored heading angle of the lower mechanism stored when the lower mechanism is powered off for previous time or a seventh heading angle of the lower mechanism collected by the second sensor in a case where the split machine is in the non-travel state and the lower mechanism is in a power-on state; and taking the sixth heading angle as the actual heading angle of the lower mechanism in a case where the fifth absolute value is greater than a fourth preset threshold.

In some embodiments, the sixth heading angle is the third stored heading angle in a case where the split machine is in the non-travel state and the lower mechanism is in the power-off state; and the sixth heading angle is the seventh heading angle in a case where the split machine enters the non-travel state from a second travel state, and a duration of the lower mechanism being in a power-on state when the split machine is in the non-travel state is greater than or equal to a second preset time.

In some embodiments, the preset position comprises a plurality of positions.

According to still another aspect of the present disclosure, an angle determining device is provided. The angle determining device comprises: a memory; and a processor coupled to the memory and, based on instructions stored in the memory, configured to: obtain angle data when an upper mechanism of a split machine rotates to a preset position, wherein the angle data comprise a first heading angle of the upper mechanism collected by a first sensor and a second heading angle of a lower mechanism of the split machine collected by a second sensor; determine a first absolute value of a difference between the first heading angle and the second heading angle; and determine an actual heading angle of the lower mechanism according to the second heading angle and determine an actual heading angle of the upper mechanism according to the second heading angle and an actual rotation angle between the upper mechanism being at the preset position and the lower mechanism, in a case where a second absolute value of a difference between the first absolute value and the actual rotation angle is greater than a first preset threshold.

In some embodiments, the processor is configured to determine the actual heading angle of the upper mechanism according to a sum of the second heading angle and the actual rotation angle.

In some embodiments, the processor is further configured to: obtain a third heading angle of the upper mechanism, the third heading angle being collected by the first sensor when the split machine is started; determine a third absolute value of a difference between a first stored heading angle of the upper mechanism when the upper mechanism is powered off for previous time and the third heading angle; and take the first stored heading angle as the actual heading angle of the upper mechanism in a case where the third absolute value is greater than a second preset threshold.

In some embodiments, the processor is further configured to: obtain a fourth heading angle of the lower mechanism, the fourth heading angle being collected by the second sensor when the split machine is started; determine a fourth absolute value of a difference between a second stored heading angle of the lower mechanism when the lower mechanism is powered off for previous time and the fourth heading angle; and take the second stored heading angle as the actual heading angle of the lower mechanism in a case where the fourth absolute value is greater than a third preset threshold.

In some embodiments, the processor is further configured to: obtain a fifth heading angle of the lower mechanism, the fifth heading angle being collected by the second sensor in a case where the split machine enters a first travel state from a non-travel state and a duration of the first travel state is less than a first preset time; determine a fifth absolute value of a difference between the fifth heading angle and a sixth heading angle, wherein the sixth heading angle is a third stored heading angle of the lower mechanism stored when the lower mechanism is powered off for previous time or a seventh heading angle of the lower mechanism collected by the second sensor in a case where the split machine is in the non-travel state and the lower mechanism is in a power-on state; and take the sixth heading angle as the actual heading angle of the lower mechanism in a case where the fifth absolute value is greater than a fourth preset threshold.

In some embodiments, the sixth heading angle is the third stored heading angle in a case where the split machine is in the non-travel state and the lower mechanism is in the power-off state; and the sixth heading angle is the seventh heading angle in a case where the split machine enters the non-travel state from a second travel state, and a duration of the lower mechanism being in a power-on state when the split machine is in the non-travel state is greater than or equal to a second preset time.

In some embodiments, the preset position comprises a plurality of positions.

According to still another aspect of the present disclosure, a program controller is provided. The program controller comprises: the angle determining device according to any of the above-described embodiments.

According to still another aspect of the present disclosure, an angle determining system is provided. The angle determining system comprises: the program controller according to any of the above-described embodiments; the first sensor configured to collect a heading angle of the upper mechanism, wherein the heading angle of the upper mechanism comprises the first heading angle; and the second sensor configured to collect a heading angle of the lower mechanism, wherein the heading angle of the lower mechanism comprises the second heading angle.

In some embodiments, the angle determining system further comprises: an induction switch configured to send an indication signal when the upper mechanism rotates to the preset position, to indicate the angle determining device to obtain the angle data when the upper mechanism rotates to the preset position.

In some embodiments, the induction switch comprises a transmitter and a receiver, one of the transmitter and the receiver being arranged at the upper mechanism and the other being arranged at the lower mechanism; and the transmitter is configured to transmit an induction signal, and the receiver is configured to determine that the upper mechanism rotates to the preset position when receiving the induction signal.

According to still another aspect of the present disclosure, a split machine is provided. The split machine comprises: the angle determining system according to any of the above-described embodiments.

According to still another aspect of the present disclosure,

a non-transitory computer-readable storage medium is provided. The non-transitory computer-readable storage medium comprises computer program instructions that, when executed by a processor, implement the angle determining method according to any of the above-described embodiments.

The technical solutions of the present disclosure will be further described in detail below by way of the accompanying drawings and embodiments.

### BRIEF DESCRIPTION OF THE ACCOMPANYING DRAWINGS

To explain the embodiments of the present disclosure or the technical solutions in the prior art more explicitly, the accompanying drawings required to be used in the description of the embodiments or the prior art will be briefly introduced below. It is apparent that, the accompanying drawings illustrated below are merely some of the embodiments of the present disclosure. For those of ordinary skill in the art, other accompanying drawings may also be obtained according to these accompanying drawings on the premise that no inventive effort is involved.

FIG. 1 is a flowchart of an angle determining method according to some embodiments of the present disclosure.

FIG. 2 is a flowchart of an angle determining method according to other embodiments of the present disclosure.

FIG. 3 is a flowchart of an angle determining method according to still other embodiments of the present disclosure.

FIG. 4 is a flowchart of an angle determining method according to yet other embodiments of the present disclosure.

FIG. 5 is a structural schematic view of an angle determining device according to some embodiments of the present disclosure.

FIG. 6 is a structural schematic view of an angle determining device according to other embodiments of the present disclosure.

FIG. 7 is a schematic view of a split machine according to some embodiments of the present disclosure.

### DETAILED DESCRIPTION

The technical solutions in the embodiments of the present disclosure will be explicitly and completely described below in conjunction with the accompanying drawings in the embodiments of the present disclosure. Apparently, the embodiments described are merely some of the embodiments of the present disclosure, rather than all of the embodiments. On the basis of the embodiments of the present disclosure, all the other embodiments obtained by those of ordinary skill in the art on the premise that no inventive effort is involved shall fall into the protection scope of the present disclosure.

Unless otherwise specified, the relative arrangements of the components and steps, numerical expressions, and numerical values expounded in these embodiments shall not limit the scope of the present disclosure.

At the same time, it should be understood that, for ease of description, the dimensions of various parts shown in the accompanying drawings are not necessarily drawn according to actual proportional relations.

Techniques, methods, and apparatus known to those of ordinary skill in the relevant art may not be discussed in detail, but where appropriate, these techniques, methods, and apparatuses should be considered as part of this specification.

Among all the examples shown and discussed here, any specific value shall be construed as being merely exemplary, rather than as being restrictive. Thus, other examples in the exemplary embodiments may have different values.

It is to be noted that: similar numerals and letters present similar items in the following accompanying drawings, and therefore, once an item is defined in one accompanying drawing, it does not need to be further discussed in the subsequent accompanying drawings.

In addition, in the description of the present disclosure, the terms such as “first”, “second”, and “third” are used for descriptive purposes only, and cannot be understood to indicate or imply relative importance and sequence. Similarly, although operations are depicted in a particular order in the accompanying drawings, this should not be understood as requiring that such operations be performed in the particular order shown, or that all the illustrated operations be performed to achieve a desired result. In some cases, multitasking processing and parallel processing may be advantageous.

In the related art, a relative rotation angle may be measured by a sensor. However, the inventors have noticed that, since the split machine usually operates for a long time, and the sensor is likely to generate certain errors in a case of cumulatively running for a long time, an accurate relative rotation angle cannot be obtained based on the sensor on the split machine.

To solve the above-described problem, the embodiments of the present disclosure provide the following solutions.

In the present disclosure, the relative rotation angle of the split machine may be determined by using a difference between a heading angle of an upper mechanism of the split machine and a heading angle of a lower mechanism of the split machine.

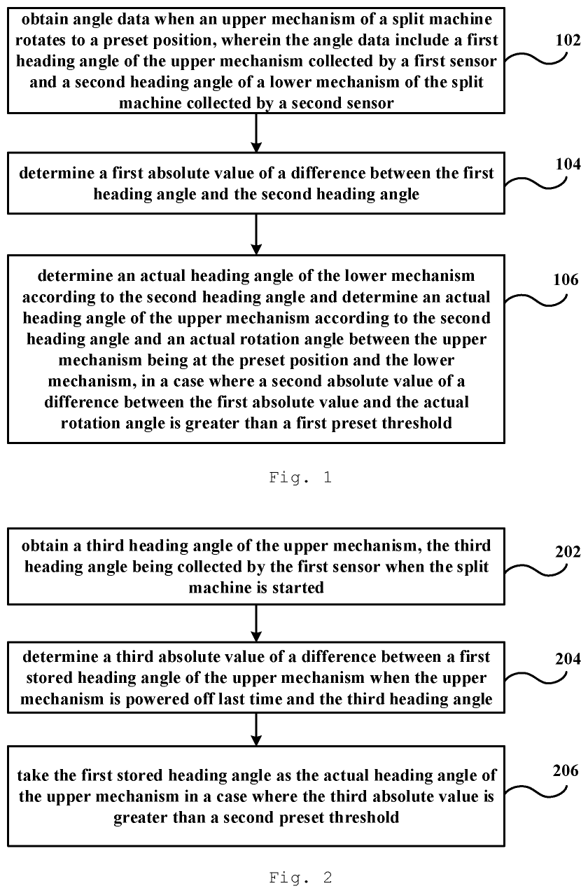

FIG. 1 is a flowchart of an angle determining method according to some embodiments of the present disclosure.

In step 102, angle data when an upper mechanism of a split machine rotates to a preset position are obtained. Here, the angle data comprise a first heading angle of the upper mechanism collected by a first sensor and a second heading angle of a lower mechanism of the split machine collected by a second sensor.

For example, the first sensor collects the heading angle of the upper mechanism in real time and the second sensor collects the heading angle of the lower mechanism in real time. When the upper mechanism rotates to the preset position, the heading angle of the upper mechanism collected by the first sensor at the current time is obtained as the first heading angle, and the heading angle of the upper mechanism collected by the second sensor at the current time is obtained as the second heading angle.

In some embodiments, the first sensor may be fixedly mounted to the upper mechanism of the split machine, and the second sensor may be fixedly mounted to the lower mechanism of the split machine.

In some embodiments, at least one of the first sensor or the second sensor comprises a Micro-Electro-Mechanical System (MEMS) sensor.

In some embodiments, the upper mechanism may be an upper turntable (which may comprise a cab therein) and the lower mechanism may be a lower chassis (a travel chassis).

In step 104, a first absolute value of a difference between the first heading angle and the second heading angle is determined.

In step 106, an actual heading angle of the lower mechanism is determined according to the second heading angle, and an actual heading angle of the upper mechanism is determined according to the second heading angle and an actual rotation angle between the upper mechanism being at the preset position and the lower mechanism, in a case where a second absolute value of a difference between the first absolute value and the actual rotation angle is greater than a first preset threshold.

In some embodiments, a heading angle may be described starting from a preset direction (for example, the north direction). For example, in a case of facing towards the north direction, the heading angle is 0 degree. For another example, in a case of facing towards northeast direction, the heading angle is 45 degrees north by east. For still another example, in a case of facing towards southeast, the heading angle is 135 degrees north by east.

In this way, the angle data (which comprise the first heading angle of the upper mechanism and the second heading angle of the lower mechanism) are obtained by sensors to determine the first absolute value of a difference therebetween. In the case where the second absolute value of a difference between the first absolute value and the actual rotation angle between the upper mechanism being at the preset position and the lower mechanism is greater than a first preset threshold, the actual heading angle of the lower mechanism is determined according to the second heading angle, and the actual heading angle of the upper mechanism is determined according to the second heading angle and the actual rotation angle. Thus, the relative rotation angle of the split machine when the upper mechanism rotates to the preset position can be accurately obtained.

In some embodiments, spatial attitude information of the split machine can be determined based on the relative rotation angle, and spatial attitude of the split machine can be obtained by using the spatial attitude information.

In this way, an operator can adjust the movement of the split machine based on the spatial attitude of the split machine, thereby improving the safety and the operation accuracy of the split machine.

In some embodiments, the preset position may comprise a plurality of positions.

In this way, the actual heading angle of the lower mechanism and the actual heading angle of the upper mechanism may be determined for multiple times through the plurality of positions, so that the relative rotation angle of the split machine when the upper mechanism rotates to the preset position can be obtained more accurately.

In some embodiments, the second heading angle may be taken as the actual heading angle of the lower mechanism.

In still other embodiments, the actual heading angle of the lower mechanism may be determined based on the second heading angle in a case where it is known by other methods that the second heading angle is inaccurate. For example, the second heading angle may be corrected to determine the actual heading angle of the lower mechanism.

In this way, the actual heading angle of the lower mechanism can be accurately obtained by determining the actual heading angle of the lower mechanism based on the second heading angle, thereby accurately obtaining the relative rotation angle of the split machine when the upper mechanism rotates to the preset position.

In some embodiments, the actual heading angle of the upper mechanism may be determined according to a sum of the second heading angle and the actual rotation angle. For example, the sum of the second heading angle and the actual rotation angle may be determined as the actual heading angle of the upper mechanism.

In this way, according to the sum of the second heading angle and the actual rotation angle, the accurate actual heading angle of the upper mechanism can be obtained, thereby accurately obtaining the relative rotation angle of the split machine when the upper mechanism rotates to the preset position.

The inventors have noticed that, when the split machine is immediately started, the data collected by the sensor might drift, which results in that the relative rotation angle of the split machine cannot be obtained accurately. Accordingly, the embodiments of the present disclosure also provide the following solutions.

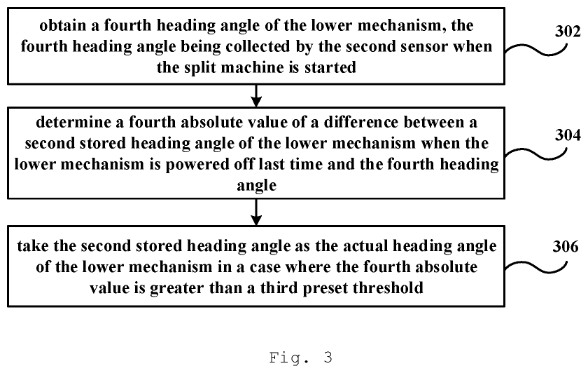

FIG. 2 is a flowchart of an angle determining method according to other embodiments of the present disclosure.

In step 202, a third heading angle of the upper mechanism is obtained, the third heading angle being collected by the first sensor when the split machine is started.

In some embodiments, the description “when the split machine is started” may refer to a time at which the upper mechanism of the split machine and the lower mechanism of the split machine enter a power-on state. For example, if the upper mechanism of the split machine and the lower mechanism of the split machine enter the power-on state from a power-off state at a certain time, this certain time is a corresponding time when the split machine is started.

In step 204, a third absolute value of a difference between a first stored heading angle of the upper mechanism when the upper mechanism is powered off for previous time and the third heading angle is determined.

In some embodiments, the description “powered off for previous time” may refer to a first time at which the power-on state for previous time is ended. The first time is before a second time at which the power-on state for this time is entered. For example, if the upper mechanism is in the power-on state from 8:00 to 9:00 and powered off at 9:00 (the first time) and powered on at 9:05 (the second time) again, the heading angle of the upper mechanism is stored as the first stored heading angle at the moment when the upper mechanism is powered off at 9:00.

In step 206, the first stored heading angle is taken as the actual heading angle of the upper mechanism in a case where the third absolute value is greater than a second preset threshold.

In this way, the third absolute value of the difference between the third heading angle obtained by a sensor when the split machine is started and the first stored heading angle when the upper mechanism is powered off for previous time is obtained. In the case where the third absolute value is greater than the second preset threshold, the first stored heading angle is taken as the actual heading angle of the upper mechanism, thereby accurately obtaining the relative rotation angle when the split machine is started.

In some embodiments, whether the communication members of the split machine are in normal operation therebetween is checked when the split machine enters the power-on state. For example, whether data transmission of the first sensor is normal is checked and/or whether data transmission of the second sensor is normal is checked.

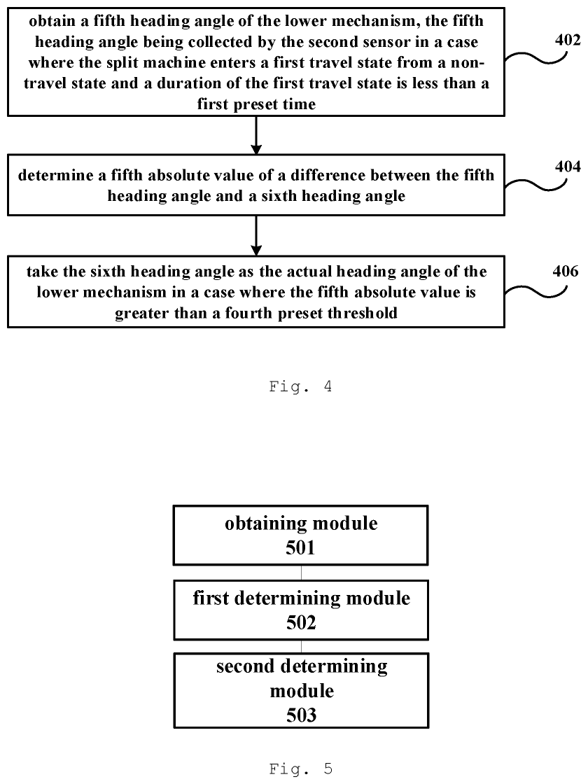

FIG. 3 is a flowchart of an angle determining method according to still other embodiments of the present disclosure.

In step 302, a fourth heading angle of the lower mechanism is obtained, the fourth heading angle being collected by the second sensor when the split machine is started.

In step 304, a fourth absolute value of a difference between a second stored heading angle of the lower mechanism when the lower mechanism is powered off for previous time and the fourth heading angle is determined.

In step 306, the second stored heading angle is taken as the actual heading angle of the lower mechanism in a case where the fourth absolute value is greater than a third preset threshold.

In this way, the fourth absolute value of a difference between the fourth heading angle obtained by a sensor when the split machine is started and the second stored heading angle when the lower mechanism is powered off previous time is obtained. In the case where the fourth absolute value is greater than the third preset threshold, the second stored heading angle is taken as the actual heading angle of the lower mechanism, thereby accurately obtaining the relative rotation angle when the split machine is started.

The inventors have also noticed that, in a case where the split machine immediately enters a travel state, the data collected by a sensor is likely to have serious errors, which results in that the relative rotation angle cannot be accurately obtained. Accordingly, the embodiments of the present disclosure also provide the following solutions.

FIG. 4 is a flowchart of an angle determining method according to yet other embodiments of the present disclosure.

In step 402, a fifth heading angle of the lower mechanism is obtained. The fifth heading angle is collected by the second sensor, in a case where the split machine enters a first travel state from a non-travel state and a duration of the first travel state is less than a first preset time. It may be understood that, when the split machine is in the travel state (for example, the first travel state), the lower mechanism drives the upper mechanism to travel.

In some embodiments, the preset time may be 60 milliseconds. The inventors have found that, in a case where a duration of the split machine in the travel state is less than 60 milliseconds, the fifth heading angle of the lower mechanism collected by the second sensor is more likely to have serious errors, resulting in that the relative rotation angle cannot be accurately obtained.

In some embodiments, the first preset time may be a machine cycle of a program controller.

In step 404, a fifth absolute value of a difference between the fifth heading angle and a sixth heading angle is determined. Here, the sixth heading angle is a third stored heading angle of the lower mechanism stored when the lower mechanism is powered off for previous time, or the sixth heading angle is a seventh heading angle of the lower mechanism collected by the second sensor in a case where the split machine is in the non-travel state and the lower mechanism is in the power-on state.

In step 406, the sixth heading angle is taken as the actual heading angle of the lower mechanism in a case where the fifth absolute value is greater than a fourth preset threshold.

In this way, the fifth absolute value of the difference between the fifth heading angle obtained by a sensor when the split machine immediately enters the travel state and the sixth heading angle is obtained. In the case where the fifth absolute value is greater than the fourth preset threshold, the sixth heading angle is taken as the actual heading angle of the lower mechanism, thereby accurately obtaining the relative rotation angle when the split machine immediately enters the travel state.

In some embodiments, in a case where a travel speed of the split machine is not 0, the split machine is considered to be in the travel state; and in a case where the travel speed of the split machine is 0, the split machine is considered to be in the non-travel state.

As some embodiments, the travel speed of the split machine may be obtained by the first sensor or the second sensor.

In this way, an actual travel speed of the split machine is obtained by the first sensor or the second sensor, so that the travel speed of the split machine can be obtained more accurately.

In some embodiments, a travel speed of the lower mechanism may be taken as the travel speed of the split machine.

In some embodiments, the sixth heading angle is a third stored heading angle of the lower mechanism stored when the lower mechanism is powered off for previous time, in a case where the split machine is in the non-travel state and the lower mechanism is in the power-off state. For example, if the lower mechanism of the split machine is switched from the power-off state to the power-on state, the sixth heading angle is the heading angle which is stored when the lower mechanism is powered off for previous time.

In other embodiments, the sixth heading angle is the seventh heading angle, in a case where the split machine enters the non-travel state from a second travel state, and a duration of the lower mechanism being in the power-on state when the split machine is in the non-travel state is greater than or equal to a second preset time. For example, if the split machine enters a travel state after startup, then enters a standby state, and thereinafter enters the travel state again. In this case, if the standby time of the lower mechanism in the standby state is greater than or equal to the second preset time, the sixth heading angle is the seventh heading angle of the lower mechanism collected by the second sensor.

In this way, considering that the split machine might adjust a travel direction during a travel process, the sixth heading angle is defined in different cases, thus the relative rotation angle can be accurately obtained in the case where the split machine immediately enters the travel state.

In some embodiments, the second preset time may be 1 minute.

In some embodiments, the seventh heading angle of the lower mechanism is collected by the second sensor and taken as the sixth heading angle, in a case where the split machine enters the non-travel state from the travel state, and the duration of the power-on state of the lower mechanism in the non-travel state is equal to the second preset time. For example, the second preset time is 1 minute, and when the duration is just equal to 1 minute, the second sensor collects the seventh heading angle of the lower mechanism as the sixth heading angle.

In this way, it is avoided that the obtained heading angle is inaccurate due to the second sensor running for a long time (for example, the collected heading angle is inaccurate due to accumulated errors of a sensor performing integral operation for a long time), thereby accurately obtaining the relative rotation angle in a case where the split machine immediately enters the travel state.

It should be understood that, heading angles collected by the first sensor and the second sensor are taken as the actual heading angle of the upper mechanism and the actual heading angle of the lower mechanism respectively in other cases than the cases of determining the actual heading angle mentioned in FIGS. 1 to 4. For example, in a case where the upper mechanism of the split machine does not rotate to the preset position, the heading angle of the upper mechanism collected by the first sensor may be directly taken as the actual heading angle of the upper mechanism, and the heading angle of the lower mechanism collected by the second sensor may be directly taken as the actual heading angle of the lower mechanism.

In some embodiments, at least one of the actual heading angle of the upper mechanism or the actual heading angle of the lower mechanism may be sent to a display screen for display. The display screen may be arranged in the cab, for example.

In this way, it is convenient to adjust a movement state of the split machine by displaying the actual heading angle on the display screen, so that the safety of the split machine and the operation accuracy of the split machine during the operation process are improved.

In some embodiments, the first preset threshold, the second preset threshold, the third preset threshold and the fourth preset threshold may be a same preset value, for example, each is 0.05.

In some embodiments, two of the first preset threshold, the second preset threshold, the third preset threshold and the fourth preset threshold may be a same preset value. For example, the first preset threshold is the same as the second preset threshold, the first preset threshold is the same as the third preset threshold, the first preset threshold is the same as the fourth preset threshold, the second preset threshold is the same as the third preset threshold, the second preset threshold is the same as the fourth preset threshold, or the third preset threshold is same as the fourth preset threshold.

In some embodiments, three of the first preset threshold, the second preset threshold, the third preset threshold and the fourth preset threshold may be a same preset value. For example, the first, second and third preset thresholds are the same, the first, second and fourth preset thresholds are the same, the first, third and fourth preset thresholds are the same, or the second, third and fourth preset thresholds are the same.

In some embodiments, the first preset threshold, the second preset threshold, the third preset threshold and the fourth preset threshold may be different preset values respectively.

The above different embodiments may be combined with each other to obtain the relative rotation angle more accurately. For example, any two or more of the embodiments shown in FIG. 1, 2, 3 or 4 may be combined with each other.

Various embodiments in this specification are described in a progressive manner, differences from other embodiments are mainly illustrated in each embodiment, and reference may be made to each other for the same or similar parts between various embodiments. As for the embodiments of a device, since they substantially correspond to the embodiments of a method, the description thereof is relatively simple. For relevant parts, reference may be made to the description of the embodiments of a method.

In some embodiments, the angle determining device may comprise modules for performing the angle determining method according to the above-described embodiments.

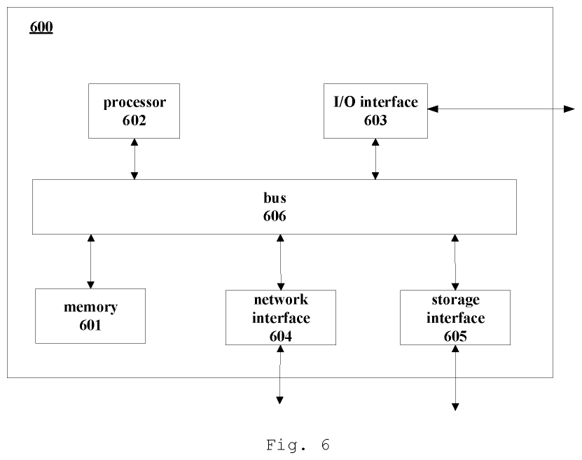

FIG. 5 is a structural schematic view of an angle determining device according to some embodiments of the present disclosure.

As shown in FIG. 5, the angle determining device comprises an obtaining module 501, a first determining module 502 and a second determining module 503.

The obtaining module 501 is configured to obtain angle data when an upper mechanism of a split machine rotates to a preset position. The angle data comprise a first heading angle of the upper mechanism collected by a first sensor and a second heading angle of a lower mechanism of the split machine collected by a second sensor.

The first determining module 502 is configured to determine a first absolute value of a difference between the first heading angle and the second heading angle.

The second determining module 503 is configured to determine an actual heading angle of the lower mechanism according to the second heading angle and determine an actual heading angle of the upper mechanism according to the second heading angle and an actual rotation angle between the upper mechanism being at the preset position and the lower mechanism, in a case where a second absolute value of a difference between the first absolute value and the actual rotation angle is greater than a first preset threshold.

In some embodiments, the angle determining device may further comprise other module(s) for performing the angle determining method according to any of the above-described embodiments.

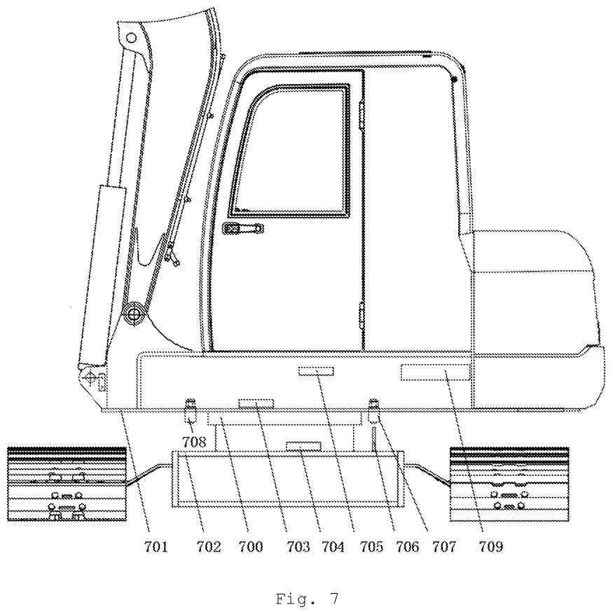

FIG. 6 is a structural schematic view of an angle determining device according to other embodiments of the present disclosure.

As shown in FIG. 6, the angle determining device 600 comprises: a memory 601 and a processor 602 coupled to the memory 601. The processor 602 is, based on instructions stored in the memory 601, configured to perform the method according to any of the afore-mentioned embodiments.

In some embodiments, the processor 602 is configured to obtain angle data when an upper mechanism of a split machine rotates to a preset position, wherein the angle data comprise a first heading angle of the upper mechanism collected by a first sensor and a second heading angle of a lower mechanism of the split machine collected by a second sensor; determine a first absolute value of a difference between the first heading angle and the second heading angle; and determine an actual heading angle of the lower mechanism according to the second heading angle and determine an actual heading angle of the upper mechanism according to the second heading angle and an actual rotation angle between the upper mechanism being at the preset position and the lower mechanism, in a case where a second absolute value of a difference between the first absolute value and the actual rotation angle is greater than a first preset threshold.

In some embodiments, the processor 602 is configured to determine the actual heading angle of the upper mechanism according to a sum of the second heading angle and the actual rotation angle.

In some embodiments, the processor 602 is further configured to: obtain a third heading angle of the upper mechanism, the third heading angle being collected by the first sensor when the split machine is started; determine a third absolute value of a difference between a first stored heading angle of the upper mechanism when the upper mechanism is powered off for previous time and the third heading angle; and take the first stored heading angle as the actual heading angle of the upper mechanism in a case where the third absolute value is greater than a second preset threshold.

In some embodiments, the processor 602 is further configured to: obtain a fourth heading angle of the lower mechanism, the fourth heading angle being collected by the second sensor when the split machine is started; determine a fourth absolute value of a difference between a second stored heading angle of the lower mechanism when the lower mechanism is powered off for previous time and the fourth heading angle; and take the second stored heading angle as the actual heading angle of the lower mechanism in a case where the fourth absolute value is greater than a third preset threshold.

In some embodiments, the processor 602 is further configured to: obtain a fifth heading angle of the lower mechanism, the fifth heading angle being collected by the second sensor in a case where the split machine enters a first travel state from a non-travel state and a duration of the first travel state is less than a first preset time; determine a fifth absolute value of a difference between the fifth heading angle and a sixth heading angle, wherein the sixth heading angle is a third stored heading angle of the lower mechanism stored when the lower mechanism is powered off for previous time or a seventh heading angle of the lower mechanism collected by the second sensor in a case where the split machine is in the non-travel state and the lower mechanism is in a power-on state; and take the sixth heading angle as the actual heading angle of the lower mechanism in a case where the fifth absolute value is greater than a fourth preset threshold.

In some embodiments, the sixth heading angle is the third stored heading angle in a case where the split machine is in the non-travel state and the lower mechanism is in a power-off state; and the sixth heading angle is the seventh heading angle in a case where the split machine enters the non-travel state from a second travel state, and a duration of the lower mechanism being in the power-on state when the split machine is in the non-travel state is greater than or equal to a second preset time.

In some embodiments, the preset position comprises a plurality of positions.

The memory 601 may comprise, for example, a system memory, a fixed non-volatile storage medium, and the like. The system memory may store, for example, an operation system, an application program, a boot loader, and other programs.

The angle determining device 600 may further comprise an I/O interface 603, a network interface 604, a storage interface 605, and the like. The I/O interface 603, the network interface 604 and the storage interface 605 therebetween as well as the memory 601 and the processor 602 therebetween may be connected, for example, via a bus 606. The I/O interface 603 provides a connection interface for input/output devices such as a display, a mouse, a keyboard, or a touch screen. The network interface 604 provides a connection interface for various networked devices. The storage interface 605 provides a connection interface for an external storage device such as an SD card or a USB flash disk.

The embodiments of the present disclosure also provide a program controller, which comprises the angle determining device according to any of the above-described embodiments.

The embodiments of the present disclosure also provide an angle determining system, which comprises the program controller according to any of the above-described embodiments, the first sensor and the second sensor. Here, the first sensor is configured to collect a heading angle of the upper mechanism, wherein the heading angle of the upper mechanism comprises the first heading angle; and the second sensor is configured to collect a heading angle of the lower mechanism, wherein the heading angle of the lower mechanism comprises the second heading angle.

In some embodiments, the angle determining system further comprises an induction switch. Here, the induction switch is configured to send an indication signal when the upper mechanism rotates to the preset position, to indicate the angle determining device to obtain the angle data when the upper mechanism rotates to the preset position.

In some embodiments, the induction switch comprises a transmitter and a receiver. Here, one of the transmitter and the receiver is arranged at the upper mechanism and the other is arranged at the lower mechanism. The transmitter is configured to transmit an induction signal, and the receiver is configured to determine that the upper mechanism rotates to the preset position when receiving the induction signal. It should be understood that the number of the transmitter(s) may be one or more, and the number of the receiver(s) may also be one or more. As some implementations, the number of the transmitter is one, and the number of the receivers is more than one, for example, two. For each receiver, it is determined that the upper mechanism rotates to the preset position as long as receiving the induction signal.

In some embodiments, the induction switch comprises a magnetic sensor and/or an infrared sensor.

The embodiments of the present disclosure also provide a split machine, which comprises the angle determining system according to any of the above-described embodiments. In some embodiments, the split machine may be an excavator.

FIG. 7 is a schematic view of a split machine according to some embodiments of the present disclosure.

As shown in the accompanying drawing, the split machine comprises a slewing bearing 700, an upper mechanism 701, a lower mechanism 702, a first sensor 703, a second sensor 704, a wireless receiver 705, a receiver 706, a transmitter 707, a transmitter 708 and a program controller 709. Here, the program controller 709 may comprise the angle determining device according to any of the above-described embodiments.

In some embodiments, the upper mechanism 701 and the lower mechanism 702 are connected through the slewing bearing 700. As some embodiments, the upper mechanism 701 may be fixedly mounted at an upper part of the slewing bearing 700, the lower mechanism 702 may be fixedly mounted at a lower part of the slewing bearing 700, and the upper mechanism 701 may freely rotate within 360 degrees by way of transitional connection of the slewing bearing 100.

In some embodiments, a display screen (not shown) is provided in the upper mechanism 701.

In some embodiments, the first sensor 703 is fixedly mounted to the upper mechanism 701, and the first sensor 703 is connected to the program controller 709 through a data line to transmit the heading angle data.

In some embodiments, the second sensor 704 is fixedly mounted to the lower mechanism 702, and the second sensor 704 maintains signal communication with the wireless receiver 705 by way of wireless transmission to transmit the heading angle data. In this way, a problem of cable winding resulting from using cable communication between the upper mechanism 701 and the lower mechanism 702 is avoided.

It should be understood that, the first sensor 703 and the second sensor 704 may also collect the angle data such as a roll angle or a pitch angle, to obtain more comprehensive space attitude information.

In some embodiments, the second sensor 704 is configured to be powered by a battery.

As some embodiments, the number of batteries is not less than two. In this way, at least two batteries may be mutually used for backup and convenient replacement.

As some embodiments, the battery charge information may be shown by an indicator light on the battery or an indicator light on the second sensor 704 so that an operator acknowledges the remaining battery charge, or the battery charge information may be sent to the program controller 709 through a wireless signal so that an operator acknowledges the remaining battery charge.

In some embodiments, the wireless receiver 705 is fixedly mounted to the upper mechanism 701 and connected to the program controller 709 through a data line to transmit the heading angle data from the second sensor 704.

In some embodiments, the program controller 709 continuously receives the heading angle data from the first sensor 703 and the heading angle data from the second sensor 704, and may perform data storage.

The embodiments of the present disclosure further provide a non-transitory computer-readable storage medium comprising computer program instructions that, when executed by a processor, implement the angle determining method according to any of the above-described embodiments.

Hereto, various embodiments of the present disclosure have been described in detail. Some details well known in the art are not described to avoid obscuring the concept of the present disclosure. According to the above description, those skilled in the art would fully understand how to implement the technical solutions disclosed here.

Various embodiments in this specification are described in a progressive manner, and each embodiment focuses on description of difference from other embodiments. For the same or similar parts between various embodiments, reference may be made to each other. As for the embodiments of the device and the vehicle, since they substantially correspond to the embodiments of the method, the descriptions are relatively simple. For the relevant parts, reference may be made to the description of the embodiments of the method.

Those skilled in the art should understand that the embodiments of the present disclosure may be provided as a method, a system, or a computer program product. Accordingly, the present disclosure may take the form of an entirely hardware embodiment, an entirely software embodiment, or a combination of software and hardware aspects. Moreover, the present disclosure may take the form of a computer program product implemented on one or more computer-usable non-transitory storage media (comprising but not limited to a disk memory, a CD-ROM, an optical memory, and the like) with computer usable program codes thereon.

The present disclosure is described with reference to the flowcharts and/or block diagrams of methods, devices (systems), and computer program products according to the embodiments of the present disclosure. It should be understood that: a function specified in one or more processes in the flowcharts and/or one or more blocks in the block diagrams may be implemented by computer program instructions. These computer program instructions may be provided to a processor of a general purpose computer, a special purpose computer, an embedded processing machine, or other programmable data processing devices to produce a machine, such that a device for implementing a function specified in one or more processes of flowcharts and/or one or more blocks in block diagrams is produced by the instructions executed by a processor of a computer or other programmable data processing devices.

These computer program instructions may also be stored in a computer readable memory that can guide a computer or other programmable data processing devices to operate in a particular manner, such that the instructions stored in the computer readable memory produce an article of manufacture comprising an instruction device. The instruction device implements a function specified in one or more processes in flow charts or one or more blocks in block diagrams.

These computer program instructions may also be loaded onto a computer or other programmable data processing devices to perform a series of operational steps on the computer or other programmable devices to produce a computer-implemented process, such that the instructions executed on the computer or other programmable devices provide steps for implementing a function specified in one or more processes of the flowcharts and/or one or more blocks in the block diagrams.

Although some specific embodiments of the present disclosure have been described in detail by way of examples, those skilled in the art should understand that the above examples are only for the purpose of illustration but not for limiting the scope of the present disclosure. It should be understood by those skilled in the art that modifications to the above embodiments and equivalently substitution of a part of the technical features can be made without departing from the scope and spirit of the present disclosure. The scope of the present disclosure is defined by the appended claims.

What is claimed is:

1. An angle determining method, comprising:
obtaining angle data when an upper mechanism of a split machine rotates to a preset position, wherein the angle data comprise a first heading angle of the upper mechanism collected by a first sensor and a second heading angle of a lower mechanism of the split machine collected by a second sensor;
determining a first absolute value of a difference between the first heading angle and the second heading angle; and
determining an actual heading angle of the lower mechanism according to the second heading angle and determining an actual heading angle of the upper mechanism according to the second heading angle and an actual rotation angle between the upper mechanism being at the preset position and the lower mechanism, in a case where a second absolute value of a difference between the first absolute value and the actual rotation angle is greater than a first preset threshold.

2. The angle determining method according to claim 1, wherein the determining an actual heading angle of the upper mechanism according to the second heading angle and the actual rotation angle comprises:
determining the actual heading angle of the upper mechanism according to a sum of the second heading angle and the actual rotation angle.

3. The angle determining method according to claim 1, further comprising:
obtaining a third heading angle of the upper mechanism, the third heading angle being collected by the first sensor when the split machine is started;
determining a third absolute value of a difference between a first stored heading angle of the upper mechanism when the upper mechanism is powered off for previous time and the third heading angle; and
taking the first stored heading angle as the actual heading angle of the upper mechanism in a case where the third absolute value is greater than a second preset threshold.

4. The angle determining method according to claim 1, further comprising:
obtaining a fourth heading angle of the lower mechanism, the fourth heading angle being collected by the second sensor when the split machine is started;
determining a fourth absolute value of a difference between a second stored heading angle of the lower mechanism when the lower mechanism is powered off for previous time and the fourth heading angle; and
taking the second stored heading angle as the actual heading angle of the lower mechanism in a case where the fourth absolute value is greater than a third preset threshold.

5. The angle determining method according to claim 1, further comprising:
obtaining a fifth heading angle of the lower mechanism, the fifth heading angle being collected by the second sensor in a case where the split machine enters a first travel state from a non-travel state and a duration of the first travel state is less than a first preset time;
determining a fifth absolute value of a difference between the fifth heading angle and a sixth heading angle, wherein the sixth heading angle is a third stored heading angle of the lower mechanism stored when the lower mechanism is powered off for previous time or a seventh heading angle of the lower mechanism collected by the second sensor in a case where the split machine is in the non-travel state and the lower mechanism is in a power-on state; and
taking the sixth heading angle as the actual heading angle of the lower mechanism in a case where the fifth absolute value is greater than a fourth preset threshold.

6. The angle determining method according to claim 5, wherein:
the sixth heading angle is the third stored heading angle in a case where the split machine is in the non-travel state and the lower mechanism is in a power-off state; and
the sixth heading angle is the seventh heading angle in a case where the split machine enters the non-travel state from a second travel state, and a duration of the lower mechanism being in the power-on state when the split machine is in the non-travel state is greater than or equal to a second preset time.

7. The angle determining method according to claim 1, wherein the preset position comprises a plurality of positions.

8. An angle determining device, comprising:
a memory; and
a processor coupled to the memory and, based on instructions stored in the memory, configured to:
obtain angle data when an upper mechanism of a split machine rotates to a preset position, wherein the angle data comprise a first heading angle of the upper mechanism collected by a first sensor and a second heading angle of a lower mechanism of the split machine collected by a second sensor,
determine a first absolute value of a difference between the first heading angle and the second heading angle, and
determine an actual heading angle of the lower mechanism according to the second heading angle and determine an actual heading angle of the upper mechanism according to the second heading angle and an actual rotation angle between the upper mechanism being at the preset position and the lower mechanism, in a case where a second absolute value of a difference between the first absolute value and the actual rotation angle is greater than a first preset threshold.

9. The angle determining device according to claim 8, wherein the processor is configured to determine the actual heading angle of the upper mechanism according to a sum of the second heading angle and the actual rotation angle.

10. The angle determining device according to claim 8, wherein the processor is further configured to:
obtain a third heading angle of the upper mechanism, the third heading angle being collected by the first sensor when the split machine is started;
determine a third absolute value of a difference between a first stored heading angle of the upper mechanism when the upper mechanism is powered off for previous time and the third heading angle; and
take the first stored heading angle as the actual heading angle of the upper mechanism in a case where the third absolute value is greater than a second preset threshold.

11. The angle determining device according to claim 8, wherein the processor is further configured to:
obtain a fourth heading angle of the lower mechanism, the fourth heading angle being collected by the second sensor when the split machine is started;
determine a fourth absolute value of a difference between a second stored heading angle of the lower mechanism when the lower mechanism is powered off for previous time and the fourth heading angle; and
take the second stored heading angle as the actual heading angle of the lower mechanism in a case where the fourth absolute value is greater than a third preset threshold.

12. The angle determining device according to claim 8, wherein the processor is further configured to:
obtain a fifth heading angle of the lower mechanism, the fifth heading angle being collected by the second sensor in a case where the split machine enters a first travel state from a non-travel state and a duration of the first travel state is less than a first preset time;
determine a fifth absolute value of a difference between the fifth heading angle and a sixth heading angle, wherein the sixth heading angle is a third stored heading angle of the lower mechanism stored when the lower mechanism is powered off for previous time or a seventh heading angle of the lower mechanism collected by the second sensor in a case where the split machine is in the non-travel state and the lower mechanism is in a power-on state; and
take the sixth heading angle as the actual heading angle of the lower mechanism in a case where the fifth absolute value is greater than a fourth preset threshold.

13. The angle determining device according to claim 12, wherein:
the sixth heading angle is the third stored heading angle in a case where the split machine is in the non-travel state and the lower mechanism is in a power-off state; and
the sixth heading angle is the seventh heading angle in a case where the split machine enters the non-travel state from a second travel state, and a duration of the lower mechanism being in the power-on state when the split machine is in the non-travel state is greater than or equal to a second preset time.

14. The angle determining device according to claim 8, wherein the preset position comprises a plurality of positions.

15. A program controller, comprising the angle determining device according to claim 8.

16. An angle determining system, comprising:
the program controller according to claim 15;
the first sensor configured to collect a heading angle of the upper mechanism, wherein the heading angle of the upper mechanism comprises the first heading angle; and
the second sensor configured to collect a heading angle of the lower mechanism, wherein the heading angle of the lower mechanism comprises the second heading angle.

17. The angle determining system according to claim 16, further comprising:
an induction switch configured to send an indication signal when the upper mechanism rotates to the preset position, to indicate the angle determining device to obtain the angle data when the upper mechanism rotates to the preset position.

18. The angle determining system according to claim 17, wherein:
the induction switch comprises a transmitter and a receiver, one of the transmitter and the receiver being arranged at the upper mechanism and the other being arranged at the lower mechanism; and
the transmitter is configured to transmit an induction signal, and the receiver is configured to determine that the upper mechanism rotates to the preset position when receiving the induction signal.

19. A split machine, comprising the angle determining system according to claim 16.

20. A non-transitory computer-readable storage medium, comprising computer program instructions that, when executed by a processor, implement the angle determining method according to claim 1.
